(19) United States
(12) Patent Application Publication
(10) Pub. No.: US 2007/0015426 A1
(43) Pub. Date: Jan. 18, 2007

(54) Environmentally friendly yarn and fabric

(76) Inventors: Ali Ahmed, Dothan, AL (US); Coley Mathis, Dothan, AL (US); Gena Webb, Dothan, AL (US); Stephen Jaarsma, Dothan, AL (US)

Correspondence Address: DICKSTEIN SHAPIRO LLP, 1177 AVENUE OF THE AMERICAS (6TH AVENUE), NEW YORK, NY, 10036-2714, US

(21) Appl. No.: 11/183,523

(22) Filed: Jul. 18, 2005

(51) Int. Cl. B32B 27/12; B32B 25/02; B32B 27/04; D04H 1/00; D04H 3/00; D04H 5/00

(52) U.S. Cl. 442/361; 428/296.7; 442/364; 442/136

(57) ABSTRACT

A monofilament or multifilament, high tenacity, polypropylene, polyethylene, propylene based copolymer, ethylene based copolymer, olefin, or fiberglass core yarn is extruded with a coating comprising a mixture of polypropylene, ethylene octane copolymer to form a monofilament yarn. The coating may also include a flame retardant, a pigment, an ultraviolet inhibitor or a lubricant. This yarn is inherently recyclable, and possesses none of the ecological and health concerns associated with commonly used polyvinyl chloride (PVC) coated yarns. The yarn overcomes the potential health risks, meets flame resistance standards, and ideally replaces PVC products. Bonded, woven fabrics employing the yarn are also recyclable, environmentally friendly, and perform as well as fabrics utilizing a PVC coated yarn. Such fabric makes an ideal interior window shades, wall coverings, and seating material in typical commercial, residential, or automotive interior applications.

### BACKGROUND OF THE INVENTION

Yarn comprises continuous strands of twisted threads of natural or synthetic materials, which are used in weaving or knitting fabrics. Threads used to make yarn are fine cords of fibrous material, such as cotton, flax, wool or nylon, which are twisted together to form the threads.

With the advent of synthetic plastic coating materials, such as polyvinyl chloride (PVC), fabrics were created that utilize a PVC coated yarn. Such fabrics have increased durability and wear properties, unrivaled by fabrics made from natural fibers alone.

One application for such fabrics is window shades. These shades are commonly used in homes and businesses to reduce glare and unwanted light while allowing desirable light to enter a room or structure. The shades reduce light and heat transmitted to the interior of a structure, and create an aesthetically pleasing and comfortable environment, while reducing energy costs. Many businesses and commercial sites utilize shades made from a synthetic woven fabric consisting of bonded PVC coated polyester yarns such as described U.S. Pat. No. 4,587,997. This shade fabric has been found to be ideal for commercial and corporate settings due to its functional properties as a shade material, aesthetically pleasing appearance, and ability to block out glare and sunlight while allowing a clear unobstructed view.

However, there has been a growing desire among environmentally concerned consumers in Europe and the United States to replace PVC materials. PVC based shade products cannot be recycled due to differences in the polymers that make up the polyester core and the PVC coating material. These shades must be disposed. Unfortunately, PVC cannot be disposed in an environmentally responsible manner. It cannot be incinerated without resulting in harmful emissions. Landfills full of PVCs can result in harmful chemicals leaching into the ground water. Even the production of PVCs creates toxic compounds and emissions, such as dioxin, chlorine, and vinyl chloride monomer. Furthermore, everyday use of PVC products results in emissions of phthalate plasticizers and other additives, which are thought to be harmful to humans. Because of these concerns, environmentally friendly or “green” yarns are needed for fabric applications such as window shades, that rival the durability of PVC coated yarns yet unlike PVC, utilize non-toxic chemicals during production, reduce or eliminate harmful emissions during use, and can be recycled at the end of the product's utility.

### BRIEF SUMMARY OF THE INVENTION

A monofilament or multifilament, high tenacity, polypropylene, polyethylene, propylene based copolymer, ethylene based copolymer, olefin, or fiberglass core yarn is extruded with a coating comprising a mixture of polypropylene, ethylene octane copolymer to form a monofilament yarn. The coating may also include a flame retardant, a pigment, an ultraviolet inhibitor or a lubricant. This yarn is inherently recyclable, and possesses none of the ecological and health concerns associated with commonly used polyvinyl chloride (PVC) coated yarns. The yarn overcomes the potential health risks, meets flame resistance standards, and ideally replaces PVC products. Bonded, woven fabrics employing the yarn are also recyclable, environmentally friendly, and perform as well as fabrics utilizing a PVC coated yarn. Such fabric makes an ideal interior window shades, wall coverings, and seating material in typical commercial, residential, or automotive interior applications.

In one aspect, the present invention is directed to a continuous monofilament polymeric yarn, comprising: a multifilament core; and a coating comprising: a thermoplastic olefin

In another aspect of the present invention, the coating further comprises; a pigment and a flame retardant.

In another aspect of the present invention, said yarn has a uniform circular cross section having a diameter of 0.25 to 1.25 millimeters.

In another aspect of the present invention, said thermoplastic olefin is one of a group consisting of polypropylene, polyethylene and a copolymer consisting of polypropylene and polyethylene.

In another aspect of the present invention, said core comprises at least one material from a group consisting of polypropylene, polyethylene, fiberglass, acrylic, polyester, and nylon.

In another aspect of the present invention, said core comprises a polypropylene or polyethylene based copolymer.

In another aspect of the present invention, said coating further comprises an ultraviolet inhibitor.

In another aspect of the present invention, said coating further comprises a lubricant.

In another aspect of the present invention, said lubricant comprises erucimid.

In another aspect of the present invention, said coating is thermally bonded to said core.

In another aspect, the present invention is directed to a method of coating yarn, comprising: threading a multifilament core through an extruder; and coating said core with a coating comprising a thermoplastic olefin

In another aspect of the present invention, the method further comprises mixing a pigment; a flame retardant; and an ultraviolet inhibitor with the thermoplastic olefin.

In another aspect of the present invention, the method further comprises extruding a pigment in a co-extrusion line.

In another aspect, the present invention is directed to a fabric comprising: a plurality of continuous monofilament polymeric yarn strands, woven together; wherein each yarn strand comprises: a multifilament core; and a coating comprising a thermoplastic olefin.

In another aspect of the present invention, the coating comprises a pigment; a flame retardant; and an ultraviolet inhibitor.

In another aspect of the present invention, the fabric further comprises an aluminum coating.

In another aspect of the present invention, the fabric further comprises one or more yarns from a group consisting of polypropylene, acrylic, nylon and polyester.

In another aspect of the present invention, the fabric further comprises one or more coatings from a group consisting of thermoplastic olefin and polyurethane.

### BRIEF DESCRIPTION OF THE DRAWINGS

FIG. 1 shows a cross-section of an environmentally friendly yarn in a first embodiment of the invention;

FIG. 2 illustrates formulations of flame retardant coatings used in the invention;

FIG. 3 shows equipment which performs the extrusion process used to produce embodiments of the present invention;

FIG. 4 shows an embodiment of a die used to produce environmentally friendly coated yarns;

FIG. 5 shows an embodiment of a finished fabric made from environmentally friendly coated yarns; and

FIG. 6 is a flowchart that illustrates steps in a yarn and fabric production method of the present invention.

### DETAILED DESCRIPTION OF THE INVENTION

Environmentally Friendly Yarn

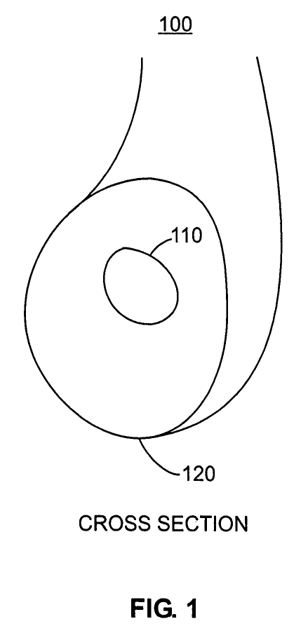

FIG. 1 shows a cross-section of an environmentally friendly yarn in a first embodiment of the invention. As shown in FIG. 1, a monofilament or multifilament core yarn 110 is preferably coated by a synthetic polymeric coating material 120. Core yarn 110 may be any number or size of yarn, but preferably comprises a 300 denier, high tenacity multifilament polypropylene core yarn with a flame retardant additive, such as Bridge Line YMH0160-300/72FR. The core yarn may alternatively be 100% polypropylene, or may consist of any combination of propylene or ethylene based compounds, olefin compatible polymers (i.e., may be recycled and bonded with olefin based coatings), or fiberglass. Alternatively, core yarn may lack a flame retardant additive, and may or may not comprise pigmentation. Preferably, core yarn filament(s) have a diameter of at least 75 denier. With coating 120, the resultant yarn has a diameter of 0.18 mm or greater, but preferably between 0.25 mm to 1.25 mm, and can have either a uniform or non-uniform cross sectional area.

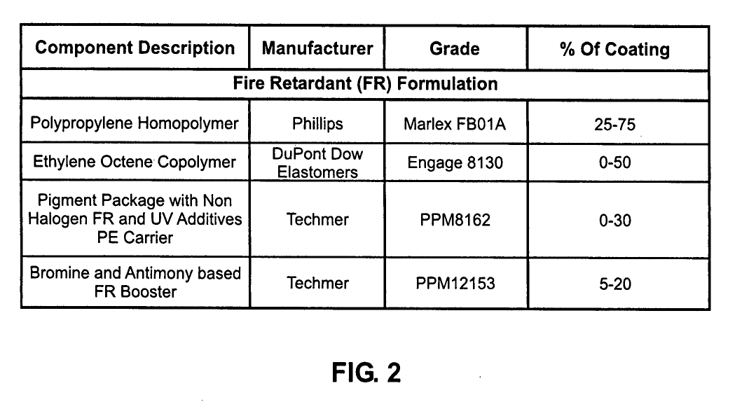

Coating 120 is any propylene or ethylene based compound, or other olefin or olefin compatible polymer that can be conventionally extruded in a single layer, or in multiple layers of these materials. Coating 120 can be a combination of different grades and percentages of polypropylene and ethylene octane copolymers, thermoplastic elastomers, or polyurethane, and may include an ethylene vinyl acetate (EVA) polymer which acts as a catalyst that promotes the ability for radio frequency welding, flame retardants, such as halogen, antimony, and phosphorous, pigments, and lubricants, such as erucimid. FIG. 2 illustrates formulations of flame retardant coatings that result in the environmentally friendly yarn of the present invention.

The formulation of environmentally friendly yarn, which is based on polypropylene and olefin copolymers, do not pose a threat to the environment due to their inherent chemical nature. Non-toxic thermoplastic olefins do not contain materials that are known toxins to humans or harmful to the environment. Thermoplastic olefins, pigments and flame-retardants that contain heavy metals would typically be toxins, and should be avoided in the formulation. Examples of such heavy metals are chlorine, bromine, chromium, antimony and zinc. Typically, pigments contain chlorine or chromium and flame retardants contain bromine and antimony, and thus should be avoided. Thermoplastics can also contain fluorine, chlorine, barium and zinc, and likewise such thermoplastics should not be included in the formulation. Lubricants that contain hazardous glycol ethers should not be used. Only additives, lubricants, and other compounds that contain organic materials (by using materials that fall within green and yellow grading areas, using McDonough Braungart Design Chemistry, LLC's (MDBC) Cradle to Cradle design protocol), such as phosphorus-based materials, should be used. Table 1 Environmentally Friendly Yarn Coating Formulations below illustrates three alternative preferred embodiments of coatings used in the invention.

TABLE 1
Environmentally Friendly Yarn Coating Formulations

| | | | |
|---|---|---|---|
| | | | % Of |
| Component Description | Manufacturer | Grade | Coating |

Flame Retardant (FR) Formulation

| | | | |
|---|---|---|---|
| Polypropylene Homopolymer | Phillips | Marlex | 41.25 |
| | | FB01A | |
| Ethylene Octane Copolymer | DuPont Dow | Engage 8130 | 33.75 |
| | Elastomers | | |
| Pigment Package with Non | Techmer | PPM8162 | 15 |
| Halogen FR and UV | | | |
| Additives PE Carrier | | | |
| Bromine and Antimony based | Techmer | PPM12153 | 10 |
| FR Booster | | | |
| 300 Denier High Tenacity | Bridge Line | YM0160 - | NA |
| Multifilament Polypropylene | | 300/72 FR | |
| Core Yarn with FR additive | | | |

Alternative FR Formulation

| | | | |
|---|---|---|---|
| Polypropylene Homopolymer | Phillips | Marlex | 26.25 |
| | | FB01A | |
| Ethylene Octene Copolymer | DuPont Dow | Engage 8411 | 48.75 |
| | Elastomers | | |
| Pigment Package with Non | Techmer | PPM8162 | 15 |
| Halogen FR and UV | | | |
| Additives, PE carrier | | | |
| Bromine and Antimony based | Techmer | PPM12153 | 10 |
| FR Booster | | | |
| 300 Denier High Tenacity | Bridge Line | YMH0160 - | NA |
| Multifilament Polypropylene | | 300/72 FR | |
| Core Yarn with FR additive | | | |

Reduced FR Formulation

| | | | |
|---|---|---|---|
| Polypropylene Homopolymer | Phillips | Marlex | 46.75% |
| | | FB01A | |
| Ethylene Octene Copolymer | DuPont Dow | Engage 8411 | 38.25% |
| | Elastomers | | |
| Pigment Package with Non | Techmer | PPM8162 | 15 |
| Halogen FR and UV | | | |
| Additives | | | |
| PE Carrier | | | |
| 300 Denier High Tenacity | Bridge Line | YMH0160 - | NA |
| Multifilament Polypropylene | | 300/72 | |
| Core Yarn | | | |

Two main coating ingredients in the core yarn, polypropylene homopolymer and ethylene octane copolymer, are made from 100% recyclable, nontoxic and environmentally safe thermoplastic olefin materials. The similarity of the core and coating material chemistry permits recycling of the yarn.

Additives included in the pigment package and core yarn have all been designed around environmentally friendly chemistry. No heavy metals should be used in any of the pigment formulations. A phosphorous-based flame retardant with no bromine or antimony component is added to the pigment and core yarn. However, the two FR preferred embodiments contain an FR booster that contains bromine and antimony based flame retardants. These FR boosters are necessary to meet flame retardant standards for interior shade fabrics, and will affect the toxicity rating of the resultant material, which would be categorized as presenting a low to moderate hazard (MDBC yellow). The reduced FR formulation does not contain bromine and antimony additives, which would be categorized as presenting little or no hazard (MDBC green).

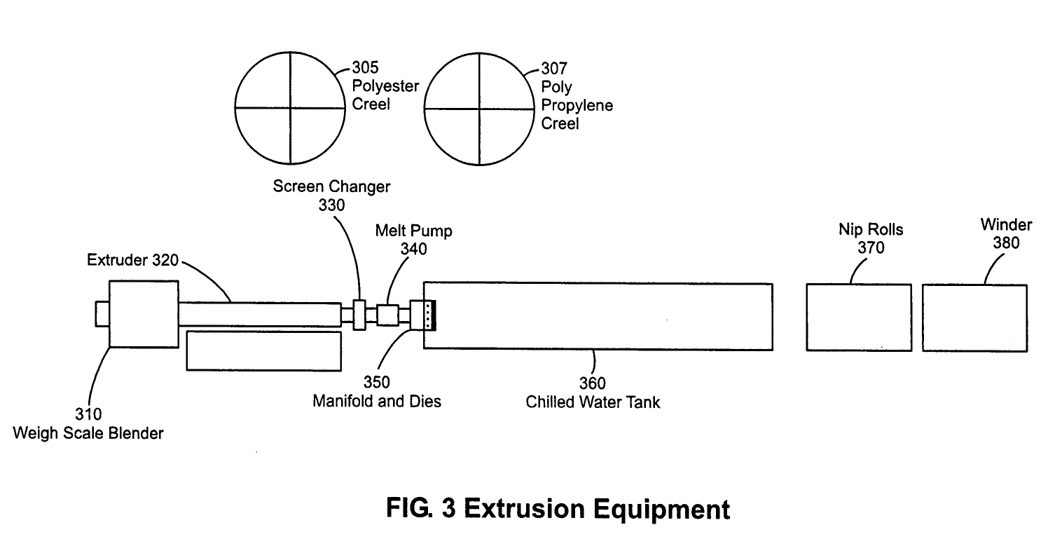

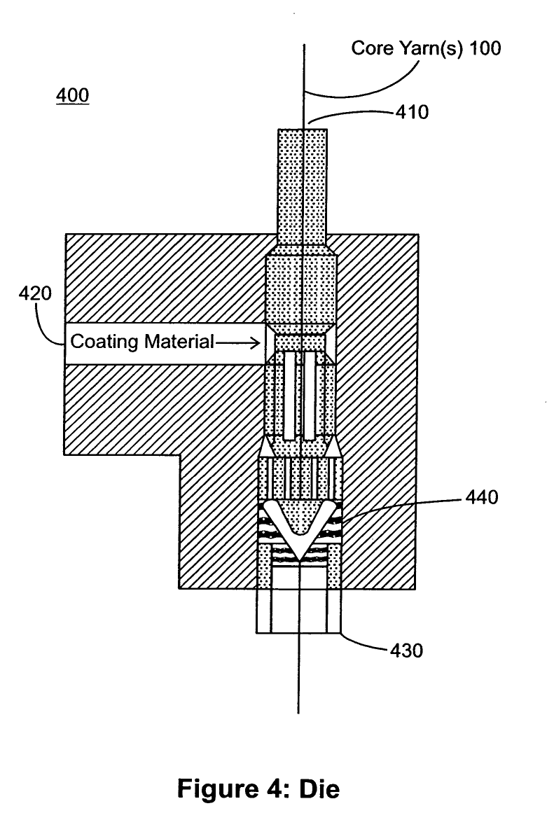

FIGS. 3 and 4 show equipment used in a process that creates the environmentally friendly yarn embodied in the present invention. Referring to FIGS. 3 and 4, this equipment comprises a set of creels 305, 307, a precision gravimetric weigh scale blender 310, preferably a Maguire model No. WSB-140R, a single screw extruder 320, preferably a Diamond America 2½ inch (63.5 mm) 24:1 LD equipped with a barrier screw with Maddock mixing section, automatic screen changer 330, preferably a Dynisco model No. EH-25, and melt pump 340 (preferably Dynisco Model No. MSDP-155) with a closed loop pressure based control system that precisely meters molten coating material in the downstream process. Attached to extruder 320 is a manifold 350 containing balanced flow channels that divide the melt into four equivalent streams, and four crosshead coating dies 400, shown in more detail in FIG. 4. Each coating die comprises a yarn inlet 410, a coating inlet 420, a nozzle 430, and a die cap 440. The finishing equipment includes a 3.6 meter chilled water tank 360, a pair of downstream nip rolls 370, and a precision cross-stitch winder 380 (preferably Leesona model No. 959 Take Up Machine).

In the preferred process, polypropylene, ethylene octane copolymer, pigment, and flame retardant booster material are blended together using precision gravimetric weigh scale blender 310 at the loading levels indicated in FIG. 2. The blended coating formulation is extruded on single screw extruder 320. As melt from the extruder is continuously forced into die heads 400, high tenacity polypropylene yarn is continuously pulled from creel 305 and through the top of each die by a pair of downstream nip rolls 370.

The position of the polypropylene core yarn is adjusted as it passes through die nozzle 430 and the melt flow of the extruded coating is oriented and balanced as it travels around nozzle 430. The core yarn comes into contact with the coating material and the final yarn profile is created in die cap 440. The four coated yarns are pulled out of die 400 and into chilled water tank 360, which is preferably positioned 30 cm below die manifold 350. Each coated yarn is then pulled through nip rollers 370 and wound on winder 380.

During startup, line speed of the extrusion equipment is relatively slow. To prevent melting the polypropylene core yarn, a polyester core yarn, dispensed from creel 307 is substituted for the polypropylene core yarn. After the normal line speed has been established, the yarn entering extruder 320 is switched to the preferred polypropylene yarn.

Preferred processing parameters used to make the environmentally friendly yarn are listed below in Table 2: Preferred Extrusion Processing Conditions. A wide range of processing conditions beyond those shown will can be used to successfully create the yarn, and different process settings and equipment may be required depending on the exact nature of the coating material and core yarn(s) used, the shape, size, and characteristics of the final product. In the case of multicolored or multi-component coated yarns, coextrusion equipment consisting of two or more single screw extruders and a multi-manifold die will be required.

TABLE 2
Preferred Extrusion Processing Conditions

| Parameter | Value |
|---|---|
| Screw Speed (rpm) | 16 |
| Extruder Loading % | 24 |
| Melt Pump Speed (rpm) | 12 |
| Melt Pump Loading % | 31 |
| Barrel Temperature Profile | Zone 1: 177, Zone 2: 188, Zone 3: 199, Zone |
| (° C.) | 4: 204, Flange: 199, Screen Changer: 199, |
| | Tube 1: 199, Pump: 199, Tube 2: 199, |
| | Die: 204 |
| Melt Temperature (° C.) | 210-220 |
| Extruder Pressure (MPa) | 4.13 |
| Melt Pump Pressure | 6.89 |
| (MPa) | |
| Die Orifice Size (mm) | Nozzle = .51, Cap = .89 |
| Quench Tank | ≦13 |
| Temperature (° C.) | |
| Line Speed (m/min) | 600-670 |
| Winder Tension (g) | 55-70 |
| Yarn Diameter (mm) | .4 |
| Yarn Yield (tex) | 137-147 |

Differences in the extrusion process should be noted from prior art PVC extrusion process. These differences require operational changes that overcome problems, increase the efficiency of production and result in a superior quality product. To avoid yarn flattening, or sticking when unwinding, winder tensions must be lowered from the prior art PVC extrusion process tensions. Compared to PVC, olefin materials are generally less heat sensitive and less prone to degradation, which permits some advantages to take place during the extrusion process. For example, the extruder temperature profile and melt temperatures are very important in both processes. These temperatures are higher for the preferred embodiment, compared to the prior art PVC process. Typically, the prior art PVC process will utilize melt temperatures between 160 and 175° C. Extrusion of PVC above this temperature range will degrade it, and extrusion below it will cause inadequate blending of PVC compound and result in variations in flow rate. If the upper end of the preferred melt temperature range (220° C.) is exceeded, then the core yarn could melt, but the coating will not degrade and contaminate the process during subsequent restart. Unlike PVC, the equipment can be returned to operation without dismantling and cleaning.

Additional differences between the two processes should be noted. For example, in the preferred embodiment, an automatic screen changer can be used to prevent downtime while replacing screen packs. Such technology would not increase efficiency during a PVC extrusion process, because relatively frequent production breaks are necessary for equipment cleaning, and the screen packs can be changed during one of these breaks. In the preferred embodiment, a melt pump is used to precisely meter molten coating material from the extruder to the die head. A closed loop pressure control system regulates melt pressure in the die head and controls extruder and melt pump speed. These controls assure uniform heat histories on all extruder material, and eliminates any variations in extruder output due to pressure surging or feed inconsistencies. The prior art PVC extrusion process does not use this melt pump technology, because PVC will degrade inside of the melt pump, due to heat and shear sensitivity of PVC. Finally, the preferred die head comprises an individual isolation valve, which permits an equipment operator to interrupt the flow of coating material to an individual strand when necessary, e.g., if a core yarn breaks and needs replacement. Extrusion of the remaining yarn strands may continue unabated. Prior art PVC extrusion degrades in the flow channel that has been interrupted, thus isolation valves could not be useful.

The average physical properties of the resultant yarn, as compared to PVC yarn of the prior art, are listed in Table 3: Yarn Physical Properties below.

TABLE 3
Yarn Physical Properties

| | | Average | |
|---|---|---|---|
| | | Value | |
| | | (FR | PVC Yarn |
| Property | Test Method | Formulation) | Avg. Value |
| Tensile Strength (N) | ASTM 2256 | 20 | 13.5 |
| Elongation (%) | ASTM 2256 | 65 | 20 |
| Hot Air Shrinkage | ASTM | 16 | 5 |
| (%) | | (130° C., | (190° C., |
| | | 2 min) | 2 min) |
| Friction Force | (Three ¾″ | 231 | 181 |
| (yarn to metal) | chrome pins, 60° | | |
| | wrap angle, 5 RMS | | |
| | value) | | |
| Diameter (mm) | Measured with | .43 | .43 |
| | Caliper | | |
| Yarn Weight (Tex) | | 142 | 208 |
| Core Yarn Weight | | 33 | 24 |
| (Tex) | | | |
| % Core Yarn by | Calculated | 23 | 12 |
| Weight | | | |
| % Coating by Weight | Calculated | 77 | 88 |

Several differences between the properties of the inventive yarn and the prior art PVC yarn are worth noting. The inventive yarn of the preferred embodiment has a higher tensile strength, because it has a larger core (33 tex versus 24 tex) and an increased core yarn tenacity (6.80 versus 6.25 g/den). The inventive yarn has significantly increased ultimate elongation and greater shrinkage at lower temperatures due to the intrinsic physical properties of polypropylene core filament, versus the polyester multifilament yarns that comprise the core of the prior art PVC yarn. The inventive yarn has a higher coefficient of friction due to the inherent properties of the coating material. The inventive yarn has a lower weight compared to PVC yarn due to the lower specific gravity of the coating material. The percentage of core yarn to coating (on a mass basis) is also higher in the inventive yarn, because of the larger core size and similar specific gravity of the core and coating materials. Finally, although not shown in the above table, the inventive yarn has an increased tackiness and coating adhesion over the prior art PVC yarn.

Depending upon the application, the resultant monofilament yarn may be twisted or bonded together with other yarns of identical, or different composition, or with other environmentally friendly yarns, such as natural yarns.

Environmentally Friendly Fabric

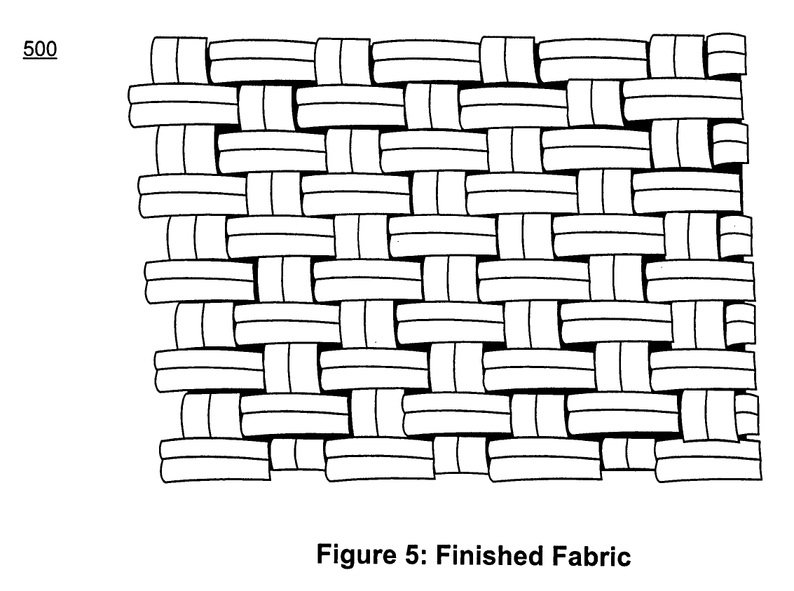

FIG. 5 shows an embodiment of a finished fabric 500 made from environmentally friendly coated yarns. Fabric 500 may be produced using any woven, knitted, or non-woven pattern. In a preferred embodiment, a plurality of environmentally friendly coated yarns 100 are woven and bonded together during a heat set process to create fabric 500. Fabric 500 may also be produced with any combination of yarns described above, and alternatively with other types of yarn beyond those described. Alternative fabric embodiments may comprise 0.25 mm diameter yarn, yarn having a non-flame resistant polypropylene core and non-flame resistant coating, and combinations of yarns having multifilament polypropylene cores. In an alternative preferred embodiment, fabric 500 may also have a coating material, such as an olefin, polyurethane, or other coating applied in any coating or laminating process. In yet another alternate preferred embodiment, the fabric is coated with aluminum by a vacuum metallization process.

Fabric 500 has been found to possess physical properties shown in Table 4: Fabric Physical Properties.

TABLE 4
Fabric Physical Properties

| Property | Test Method | Finished Fabric |
|---|---|---|
| Pigments | NA | PPM8162, |
| | | PM81628 |
| Pattern | NA | 2 over 2 basket |
| | | weave |
| Fabric Width (m) | Direct Measurement | 2.75 |
| Warp Count (ends/cm) | ASTM D3775-96 | 15.75 |
| Pick Count (ends/cm) | ASTM D3775-96 | 11 |
| Fabric Weight (g/m²) | ASTM D3776-96 | 430 |
| Tensile Strength Grab | ASTM D5034-95 | Warp: 1695, |
| (N) | | Fill: 1179 |
| Elongation (%) | ASTM D5034-95 | Warp: 40, Fill: 41 |
| Tensile Strength Strip | ASTM D5035-95 | Warp: 792, Fill: 512 |
| (N) | | |
| Tear Strength (N) | ASTM D1117-97 | Warp: 289, Fill: 191 |
| Heat Set Strength (N) | Twitchell Test Method | 4.5 |
| Abrasion Resistance | ASTM D3884-92, D3597- | No Exposure |
| | 95a | |
| Openness Factor | ASHRAE 74-1988 | 3% |
| Fade Resistance | ASTM G53-96: 1200 hrs | Pass, |
| | | still testing @ |
| | | 10,000 hrs |
| U.V. Deterioration | ASTM G53-96: 500 hrs | Pass |
| | (96% Retention) | |
| Flammability | California Title 19, NFPA | Pass |
| | 701-99 Methods 1 and 2 | |

The properties of fabric 500, shown in Table 3, may deviate from the listed values if any modifications are made to the condition of the finished fabric.

Fabric 500 is an environmentally friendly product that can be recycled, will not produce the emissions known to be associated with PVC materials, and meets stringent requirements for contract interiors and performance standards met by PVC. This fabric is useful in any application requiring performance similar to that achieved by PVC fabric. Such uses include, but not limited to, window shades, seating material, wall paneling, outdoor furniture, awnings, and automotive interiors.

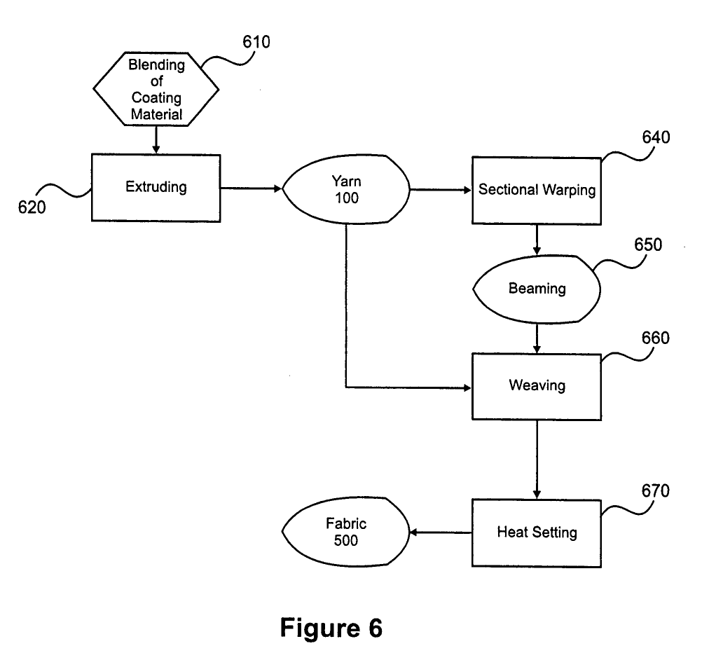

FIG. 6 is a flowchart that illustrates steps in a production method of the present invention. As shown in FIG. 6, the manufacturing steps to create the yarn comprise blending coating material 610, and extruding core yarn and coating 620, thereby creating coated yarn. Next, in a preferred fabric manufacturing process, yarn positioned on a sectional warping creel is pulled through tensioners and warped onto a sectional warper drum 640. Then the yarn is beamed off through a lubricant bath 650. After warping and beaming, the yarn is woven into a fabric 660 to produce the desired pattern. The woven fabric is then wound onto a fabric beam. Next, individual yarns which comprise the fabric are bonded together during a heat setting process 670, to create the final, finished fabric. In an alternative preferred process, warping 640 and beaming 650 steps are skipped.

Individual steps in the preferred fabric manufacturing process will be described in more detail. Beaming (or warping) is a common intermediate step in woven fabric formation in which a large number of individual yarns are pulled together in parallel and wrapped onto a cylinder, known as a warp beam, in preparation for transportation to a loom. Sectional warping is a two part process. In the first part, a relatively small number of yarn tubes are wound onto a rotating drum for a specified distance. As the yarn is wrapped around the drum, the drum moves laterally, i.e., perpendicular to the direction of the incoming yarn, and allows the yarn to build up against a tapered surface on one end of the barrel. After a specified length of yarn is wrapped, the yarn is cut and tied off, and a small section of yarn, known as a lap, remains. This process is repeated for a number of iterations until the desired width of yarn is pulled from the barrel. During the second part, known as beaming off, the laps are pulled from the barrel and wound on a warp beam. Sectional warping makes practical and economic sense when relatively short lengths of fabric, or densely woven fabric having a wide width, is produced, because it reduces the total number of yarn tubes required and increases the size of the tubes.

In warping and beaming steps 640, 650, yarn is positioned on a sectional warping creel (preferably a Benninger model No. 100522) utilizing a centrally controlled spring-loaded roller system for yarn tensioning and electronic end stop detection capability (preferably an Eltex model No. 17820 Mini-SMG 12I). Yarn pulled from the creel is threaded through the tensioners, stop motion detectors, and reed, and wound onto the drum of a sectional warper (preferably a Hacoba model No. USK 1000E-SM). The yarn is beamed off through a lubricant bath onto a warp beam, under the preferred process parameters specified below in Table 5: Beaming Process Parameters. A range of processing conditions beyond those shown in the table below may be used to produce a warp beam for fabric production, and other types of warping equipment, lubricants, or warping techniques (direct warping, etc.) may be required or used depending on the exact nature of the yarn (such as size, shape, coating material, etc.), fabric specifications, and weaving equipment.

TABLE 5
Beaming Process Parameters

| Parameter | Value |
|---|---|
| Reed | 37 Single (14.5 ends/cm) |
| Creel Setup | Alternate: 1 end, 1 end |
| Machine Setting | 135.0 |
| Beaming Speed (m/min) | 250 |
| Ends/Lap | Laps 1-22: 200, Lap 23: 112 |
| Total Ends | 4512 |
| Yarn Tension Avg. (g) | 170 |
| Beaming Lubricant (kiss coated) | Mfr: Goulston, Grade: Lurol PP6638B, |
| | Dilution 1:3 with Water |
| Beam Brake Pressure (MPa) | .4 |

Lubricants used in the prior art PVC process will not effectively reduce the friction, or tackiness, of the preferred yarn. If PVC lubricants were used, the yarn's coating would become damaged during weaving (from the increased friction of the yarn during the beat down of the reed). Particulate matter from the coating would leave residue on the low and in the fabric, thereby reducing the overall quality. PVC lubricants also negatively affect the flammability of the fabric. Through research and experimentation, the inventors have found that an olefin compatible lubricant (Goulston) works best with the preferred formulation.

In weaving step 660, the warp beam produced in steps 640, 650 is installed on a rapier style weaving machine (preferably a Dornier model No. 47316 with Dobby model No. SM-2670). The warp yarn is conveyed through the harnesses of a loom as they are raised and lowered, and lubricated fill yarn is inserted between them to produce a desired pattern. The fill yarn is preferably wound on LGL model no. Progress 3 winders, and lubricated with preferably Lang Ligon part No. A0A2S155A applicators, using Lang Ligon part No. EC-1000 applicator pads. The woven fabric is then wound onto a fabric beam.

Processing parameters used in weaving step 660 are listed below in Table 6: Weaving Process Parameters. A range of processing conditions beyond those shown below will result in the production of fabric and different process settings, lubricants, and equipment may be required depending on the exact nature of the coating material and core yarn(s) used, and the characteristics desired of the final product.

TABLE 6
Weaving Process Parameters

| Parameter | Value |
|---|---|
| Reed | 37 Single 70% Airspace |
| | (14.5 ends/cm) |
| Pattern | 2 × 2 Basket Weave. Colors |
| | Alternate 1 × 1 |
| Warp Tension | 150 |
| Filling Density (picks/cm) | 10 |
| Filling Lubricant | Mfr: Goulston Lurol PP 8126 |
| Speed (cycles/min) | 200 |
| Shed Close Angle (°) | 338 |
| Filling Tensioners Open (°) | 70, 195 |
| Filling Tensioners Close (°) | 135 |
| Filling Tensioners Open Force (%) | 20 |
| Filling Tensioners Close Force (%) | 30 |

In addition, the tension setup required to successfully weave the preferred yarn is different from PVC yarn. In general, tensions of the warp and fill yarns have been reduced to compensate for the increased yarn friction, tackiness, and tendency for particulate formation. Fill yarn winder position and brush position are adjusted to control tension. The reduced tension prevents excessive fill yarn breakage, thereby increasing loom production time. Additional measures are taken to improve the process. For example, the shed is timed to close later in the weaving cycle. This reduces the tendency of shaving off the yarn's coating. The shed timing delay must, however, be carefully balanced, because too much delay will result in an improper grip of the fill yarn by the warp yarn, and will result in a kinky fill. Stop motion sensitivity is adjusted to prevent false fill stops. Cutouts placed behind fill yarn tubes on the creel prevent the yarn from looping behind the tube and breaking. Finally, the lubricant application rate is carefully controlled so that the proper amount of lubricant is applied.

Individual yarns that compose the fabric are bonded together in heat setting step 670. In this step, the woven fabric is positioned on a finishing range (preferably a Babcock model No. D-21220) equipped with a seven zone adjustable tenter frame, four zone finishing oven, pre and post finishing fabric-straightening system (preferably a Mahlo model No. RFMC-96HX (pre-finishing) and model No. FMC-96HX (post-finishing)), forced convection air cooling zone, and chilled water cooling drums. The fabric is conveyed over a series of rollers, through a straightener, and is clipped onto the tenter frame. The tenter frame conveys the fabric through the four-zone oven where heat is applied to the surface by forced convection of air. As the oven heats the fabric, the surface of each individual yarn melts and forms a bond with adjacent perpendicular yarns, thus setting the fabric. To compensate for shrinkage of the core yarn during heat setting, the overall fabric width is decreased by adjusting the tenter frame as the fabric passes through the oven. After leaving the oven, the fabric is conveyed through a forced convection cooling section, a fabric straightener, and chilled water drums.

The preferred processing parameters used to make the fabric are listed below in Table 7: Heat Setting Process Parameters. A wide range of processing conditions beyond those shown will result in the production of heat set fabric, and different process settings or equipment may be required depending on the exact nature of the construction, coating material, and core yarn(s) used, and characteristics desired of the final product. These parameters have been determined to be optimal to produce a preferred 2.75 meter wide fabric.

TABLE 7
Heat Setting Process Parameters

| Parameter | Value |
|---|---|
| Oven Temperatures (° C.) | Zone 1: 146, Zone 2: 152, Zone 3: 152, |
| | Zone 4: |
| | 155 |
| Line Speed (m/min) | 15.6 |
| Unfinished Width (m) | 2.97 |
| Tenter Frame Width Profile | Zone 1: 2.95, Zone 2: 2.92, Zone 3: 2.9, |
| (m) | Zone 4: |
| | 2.85, Zone 5: 2.85, Zone 6: 2.85, Zone |
| | 7: 2.85 |
| Finished (cut) Width (m) | 2.75 |
| Circulating Fan Setting | High |
| Cooling Fan Setting | High |
| Chill Water Temperature | 18 |
| (° C.) | |

the major differences between heat setting the preferred fabric and PVC fabric are the oven temperature profile, the fabric width profile, the line speed, and control of the fabric straightness. These differences are much more critical in the present process from prior art process of heat setting PVC fabric.

First, temperatures in each zone of the finishing oven must be controlled to within +/−1° C. when heat setting the fabric to obtain consistent results. The semi-crystalline nature of the coating material results in a very narrow melting range compared to the amorphous PVC coated fabric, and also the potential for further crystallization and stiffening during the heat setting process. Significant changes in fabric stiffness and level of heat set will occur with even a 3° C. change in oven temperature. Temperature across the width of the fabric must also be uniformly maintained.

Zoned Temperature Profile: a zoned profile controls the polypropylene core yarn's shrinkage rate. A first oven zone has a lower temperature and a last oven zone has a higher temperature. This profile prevents the build up of excessive shrinkage force. If a flat temperature profile, such as that used for PVC fabric, were employed, the shrinkage force would pull the fabric from the tenter frame.

Fabric Width Profile: Because the core yarn has a high shrinkage level, shrinkage in the finishing oven is controlled by maintaining the fabric's width. By controlling the shrinkage, the process prevents the fabric from pulling away from the tenter frame.

Reduced Line Speed: Line speed has been slowed to help balance two opposing fabric properties, namely heat set and stiffness. The level of heat set is directly related to oven temperature as well as dwell time. In contrast, stiffness of the preferred fabric is mainly temperature dependent, and is relatively independent of dwell time. As a result, the reduced line speed allows the fabric to obtain a higher level of heat set without increasing the stiffness that would be realized if it were finished at higher temperatures.

Fabric Straightness Control: A metalite-coated strip (preferably 3M model no. 248 D Three-M-ite, type P150) is added to the post finishing fabric-straightening system to allow proper gripping of the fabric for straightening. When heat set, the polypropylene core yarn shrinks, which develops a force in the warp direction. This force causes the center of the fabric to pull back, since the center is not held by tenter frame clips. An undesired trailing bow forms, resulting in a defective fabric, which is unacceptable for commercial use. The added metalite surface provides extra traction for the post finishing straightener rollers as fabric is exits the heat setting process. Thus, the rollers can hold the fabric straight across the fabric's width.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

We claim:

1. A continuous monofilament polymeric yarn, comprising:
a multifilament core; and
a coating comprising: a thermoplastic olefin.

2. The yarn of claim 1, wherein said coating further comprises a pigment and a flame retardant.

3. The yarn of claim 1, wherein said yarn has a uniform circular cross section having a diameter of 0.25 to 1.25 millimeters.

4. The yarn of claim 1, wherein said thermoplastic olefin is one of a group consisting of polypropylene, polyethylene and a copolymer consisting of polypropylene and polyethylene.

5. The yarn of claim 1, wherein said core comprises at least one material from a group consisting of polypropylene, polyethylene, fiberglass, acrylic, polyester, and nylon.

6. The yarn of claim 5, wherein said core comprises a polypropylene or polyethylene based copolymer.

7. The yarn of claim 1, wherein said coating further comprises an ultraviolet inhibitor.

8. The yarn of claim 1, wherein said coating further comprises a lubricant.

9. The yarn of claim 8, wherein said lubricant comprises erucimid.

10. The yarn of claim 1, wherein said coating is thermally bonded to said core.

11. A method of coating yarn, comprising:
threading a multifilament core through an extruder; and
coating said core with a coating comprising a thermoplastic olefin; a pigment; a flame retardant; and an ultraviolet inhibitor.

12. The method of claim 11, further comprising mixing a pigment; a flame retardant; and an ultraviolet inhibitor with the thermoplastic olefin.

13. The method of claim 11, further comprising extruding a pigment in a co-extrusion line.

14. A fabric comprising:
a plurality of continuous monofilament polymeric yarn strands, woven together;
wherein each yarn strand comprises:
a multifilament core; and
a coating comprising a thermoplastic olefin

15. The fabric of claim 14, wherein the coating further comprises a pigment;

16. The fabric of claim 14, wherein the coating further comprises a flame retardant.

17. The fabric of claim 14, wherein the coating further comprises an ultraviolet inhibitor.

18. The fabric of claim 14, further comprising an aluminum coating.

19. The fabric of claim 14, further comprising one or more yarns from a group consisting of polypropylene, acrylic, nylon and polyester.

20. The fabric of claim 14, further comprising one or more coatings from a group consisting of thermoplastic olefin and polyurethane.
